(19) United States
(12) Patent Application Publication
(10) Pub. No.: US 2006/0015351 A1
(43) Pub. Date: Jan. 19, 2006

(54) Creating expiring copies in a check-out/check-in system

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (DE)

(21) Appl. No.: 10/534,597

(22) PCT Filed: Nov. 5, 2003
(86) PCT No.: PCT/IB03/05120

§ 371 Date: May 11, 2005

Related U.S. Application Data
(60) Provisional application No. 60/425,843, filed on Nov. 12, 2002.
(60) Provisional application No. 60/483,767, filed on Jun. 30, 2003.

(51) Int. Cl. G06Q 99/00

(52) U.S. Cl. 705/1

(57) ABSTRACT

A check-in/check-out system (100) and method creates limited-duration copies of protected content material (101). The system is configured to allow up-to-N contemporaneous copies (102) of the protected content material. A log (110) maintains a record of the copies currently outstanding, and their expiration times, after which time a conforming rendering device will cease to render the material of this expired copy. When a copy is returned, the entry in the log is deleted (270). If a copy is not returned to the system (100) before its expiration time, the system is configure to also delete its entry from the log (201), thereby allowing another copy to be made (250) to replace the expired copy, even though the expired copy has not been returned.

This invention relates to the field of consumer devices, and in particular to techniques for preventing or discouraging the illicit duplication of copy protected material. Techniques are continually being proposed and developed to prevent or discourage the illicit duplication of copy-protected material, such as commercial music recordings.

These techniques generally attempt to limit the number of copies that can be made from a legitimate copy of the copy-protected material. At the same time, the purchaser of this legitimate copy expects to have unlimited rights for copying this material for his or her private purposes. For example, the typical purchaser has access to multiple means for playing and recording the material, and expects to be able to play the purchased material on each of these means, without constraints.

Increasingly common in the art is the use of flash memory cards to record content material for playback on small portable devices. These flash memory cards, or similar electronic memory devices, have an advantage over conventional recording media such as discs or tapes, in that they contain no moving parts and are thus more reliable and robust. Similarly, the playback devices for these memory cards need not contain movement mechanisms and are therefore also more reliable, robust, and, in general, less expensive than conventional players. The electronic memory devices and corresponding players are also generally much smaller than conventional discs or tapes and corresponding players, and generally consume less power, further increasing their suitability for use as portable playback systems.

The availability of small, inexpensive media for copying copy-protected material presents a number of potential problems as the rights of the provider of the copy-protected material are balanced with the rights of the purchaser of the copy-protected material. Because the medium is small, and intended for highly portable applications, the likelihood of the medium being lost, damaged, or misplaced is high. As such, the purchaser will expect to be able to reproduce the content material as often as required to replace the lost, damaged, or misplaced copies. Contrarily, because the media is inexpensive, the likelihood of an illicit mass reproduction of the content material is high, and the provider of the material will expect to be able to prevent such an illicit mass reproduction.

One method for limiting the ability to copy the content material is a “check-out/check-in” system. In this, as in other protection schemes presented herein, it is assumed that the copying and playback devices are “conforming” devices, in that they conform to the standards used to protect copy-protected material. When a copy of the material is made from a providing device to a portable medium, the conforming providing device prevents additional copies beyond a given limit from being made until the portable medium containing the copy is returned to the providing device. That is, the check-out/check-in system provides a “one-at-a-time”, or an “at-most-N-at-a-time”, copy scheme to limit the number of simultaneously available copies of protected content material. This scheme has a number of drawbacks: if the portable copy is lost, damaged, or misplaced, it cannot be “returned” to the providing device, and subsequent other copies cannot be made. Also, the “annoyance” factor of having to check copies back in to the system from which the copy was made will adversely affect consumer acceptance of this protection scheme.

It is an object of this invention to provide a copy protection method and system that limits the number of contemporaneously available copies of protected content material. It is a further object of this invention to provide a copy protection method and system that does not necessarily require a return of issued copies of the protected content material to enable the creation of additional copies.

These objects, and others, are achieved by a check-in/check-out system and method that creates limited-duration copies of protected content material. The system is configured to allow up-to-N contemporaneous copies of the protected content material. A controller maintains a log of the copies currently outstanding, and their expiration times, after which time a conforming rendering device will cease to render the material of this expired copy.

When a copy is returned, the entry in the log is deleted. If a copy is not returned to the system before its expiration time, the system is configure to also delete its entry from the log, thereby allowing another copy to be made to replace the expired copy, even though the expired copy has not been returned.

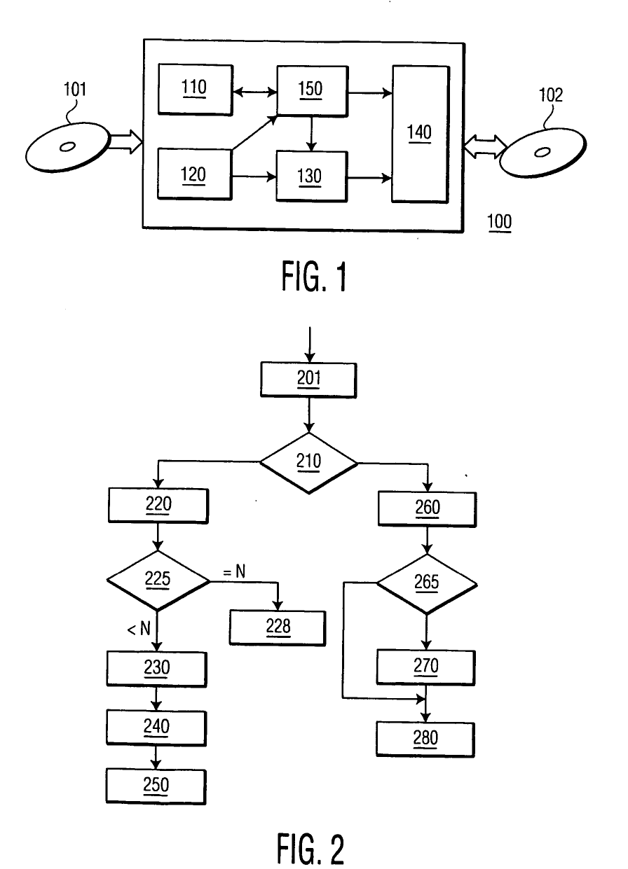

FIG. 1 illustrates an example block diagram of a check-in/check-out system in accordance with this invention.

FIG. 2 illustrates an example flow diagram of a check-in/check-out system in accordance with this invention.

Throughout the drawings, the same reference numeral refers to the same element, or an element that performs substantially the same function.

FIG. 1 illustrates an example block diagram of a check-in/check-out system 100 in accordance with this invention. The overall function of the system 100 is to allow the creation of up-to-N contemporaneously accessible copies 102 of source material 101. Although the source 101 and copy 102 are illustrated as CDs, the media can be a CD, DVD, memory sticks, magnetic disks, or any storage device that is suitable for containing the content material of the source 101.

The system 100 includes a controller 150 that is configured to control a copy device 140 that effects the copying of the source material 101 to the copy 102. The controller 150 maintains a log 110 corresponding to each source material 101, to determine whether to enable the copy device 140 for making each copy. In accordance with this invention, the log 110 includes an identification of each copy 102 and an expiration time associated with each copy 102. From this log 110, a count of the number of currently issued copies of each source 101 can be determined. As discussed further below, when a copy is made, an entry is made in the log, increasing the count by one; when a copy is returned or expires, the entry is removed from the log, decreasing the count by one. As would be evident to one of ordinary skill in the art, a separate, albeit redundant, counter can be maintained to hold this count, to expedite processing.

The controller 150 is configured to enable a marking device 130 to provide a marking to the copied material 102, via the copy device 140. Preferably, the marking is a ‘watermark’ that is indelibly added to the content material in such a way that the presence of the watermark does not noticeably affect the rendering of the material. Any of a variety of techniques are available in the art for creating and reading watermarks. Alternatively, the marking could be information added to a particular segment of the material, such as an entry in the table of contents of a CD or DVD, or an entry at a predefined memory location in a memory stick or ROM. In accordance with this invention, the marking optionally includes a mark that indicates the expiration time for this copied material. The term ‘optionally’ is used in that if a copy 102 does not have an expiration time, the inclusion of this null-expiration in the marking is optional.

In accordance with this invention, conforming rendering systems will be configured to detect the expiration time marking, if any, and will prevent the rendering of the content material from the copy if the authorization time has expired. Note that the correspondence of “time” between the copying system and the rendering system may not be one-to-one. For example, the expiration time may explicitly include the authorization-duration, and the “count-down” of the authorization may not commence until the first rendering of the copied material at the rendering system. In like manner, a portable rendering device may not be configured to maintain an active real-time clock, due to power constraints. In such an embodiment, a default “usage rule” may be used to correlate an expiration time at a source system with a usage-count at a rendering device. For example, an authorization duration of ten days may be translated to a usage-count of twenty renderings of the copied material, and the conforming rendering system is configured to prevent rendering of the copied material more than twenty times when presented an expiration duration of ten days. In each of these example embodiments, the actual expiration of rights to access the copied material at the conforming rendering system may be sooner-than or later-than the expiration time that is recorded in the log. This lack of one-to-one timing correspondence between the source device and the rendering devices has limited short-term effects. The overall effect is that some or all of the copied material has a limited useful authorization time, and the controller 150 is configured to eliminate the effects of having made the copied material after a determined expiration time.

In a preferred embodiment of this invention, the user of the system 100 defines a ‘default’ authorization-duration that is combined with the contents of a timer 120 to determine the expiration time, and is also given the option of overriding the default for particular copies 102. For example, a user who regularly downloads content material to portable memory sticks may set the default authorization-duration to three months, but may override this setting when creating a CD, to set a much longer authorization-duration. Optionally, the system 100 can be configured to allow for multiple default authorization-durations, depending upon the media 102, or other factors.

The marking may also include other material that facilitates copy control of protected material. Copending U.S. patent application “REGISTERING COPY PROTECTED MATERIAL IN A CHECK-IN, CHECK-OUT SYSTEM”, Ser. No. 09/548,728, filed 13 Apr. 2000 for Michael Epstein, Attorney Docket PHA 23,671, discloses a marking that is used in a device-specific challenge-response protocol, to assure that the media that received the copied material is the same media that is used to check the material back in, and is included by reference herein.

The controller 150 also manages the return, or check-in, of copied material 102. When the copied material 102 is returned, the controller identifies the source 101 of this material, removes the entry in the log associated with this source 101 and copy 102, and removes or other disables the contents from the copy 102. In accordance with this invention, the expiration of the authorization-duration of a copy 102 also effects a removal of the corresponding entry from the log.

FIG. 2 illustrates an example flow diagram of a check-in/check-out system in accordance with this invention. At the start of each invocation of the system 201, the log is updated to delete any entries in the log for copies that have expired, so that the current count of outstanding non-expired copies is up to date. At 210, a request is received, either to create a copy of source material, or to return a previously made copy. If the request is to create a copy, the requested source is identified, at 220. If, at 225, the current count of outstanding non-expired copies for the requested source is already at the maximum allowable, N, based on the current entries in the log for this source, the request to make an additional copy is refused, at 228.

If the current count is less than N, this copy is authorized, and the expiration time for this copy is determined, at 230. As noted above, a default authorization-duration time is preferably available, so that the copying can occur with minimal user intervention. Alternatively, the user can include a specific authorization-duration time in the copy request, or the system can prompt the user for the desired authorization-duration time. The user has the option of declaring an infinite authorization-duration time, so that no expiration time is defined. By doing so, however, the user runs the risk of eventually consuming all of the user's authorizations, if the user misplaces the copies, or the copies become damaged.

The log for this source material is updated to reflect the creation of this copy and its expiration time, if any, at 240, and a copy of the source material is created, at 250, with appropriate security markings, including the expiration time, if any. If, at 210, the request is to return a copy of the content material, the identity of the copy and its source is determined, at 260. As noted above, security procedures are preferably invoked to assure the identity of the copy, to prevent bogus or repeated returns. At 265, the log is searched to find this copy of the source material. If an entry is found that corresponds to this copy, the entry is removed from the log, at 270. If this copy had expired, and the log had been updated at 201 during this request or a prior request, an entry for this copy would no longer appear in the log, and the deletion at 270 is skipped. At 280, the content material is erased from the media of the copy, or otherwise marked as being unauthorized for subsequent rendering.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular form of the functions described above need not be identical to those illustrated. Particularly, the term “log” is used in its general sense, and can be embodied as a database, an index table, a linked list, and so on. A deletion from the log can include any activity that eliminates the effects of having made the entry in the log. For example, if the log serves purposes other than keeping track of expiration times, a flag can be used within the log to indicate whether each copy should be considered when determining whether to make another copy, and this flag can be cleared upon return of the copied material or upon expiration of the authorized time. In like manner, if the material is being returned during a request to make a new copy of the material with a later expiration time, one of ordinary skill in the art will recognize that the erasure step 280 and copy step 250 can be skipped, and the expiration time in the log can merely be updated. Similarly, if the material is being returned during a request to make a copy of different material, and the new material will overwrite the returned material, the erasure step 280 can be skipped. These and other system configuration and optimization features will be evident to one of ordinary skill in the art in view of this disclosure, and are included within the scope of the following claims.

1. A copy protection system, comprising:
a controller, operably coupled to a copy device, that is configured to maintain a log of prior copies of the source material, and to control the copy device dependent upon contents of the log, and
a marker device, operably coupled to the controller and the copy device, that is configured to attach an information item to one or more of the prior copies,
wherein
the information item includes an expiration time associated with each of the one or more of the prior copies, and
the log includes the expiration time associated with each of the one or more prior copies, and
the controller is configured to eliminate one or more effects of having made at least one copy of the one or more of the prior copies after an expiration of the expiration time associated with the at least one copy.

2. The copy protection system of claim 1, wherein
the log includes an identifier of the source material, and
the controller is configured to limit a total number of copies of the source material, based on the contents of the log.

3. The copy protection system of claim 1, wherein
the controller is further configured to:
erase a returned copy of the one or more prior copy, and
eliminate one or more effects of having made the returned copy.

4. The copy protection system of claim 3, wherein
the controller is configured to eliminate the one or more effects of having made the returned copy via a modification of the log corresponding to the returned copy.

5. The copy protection system of claim 4, wherein
the controller is configured to eliminate the one or more effects of having made the at least one copy after the expiration of the expiration time via a modification of the log corresponding to the at least one copy.

6. The copy protection system of claim 1, wherein
the controller is configured to eliminate the one or more effects of having made the at least one copy after the expiration of the expiration time via a modification of the log corresponding to the at least one copy.

7. The copy protection system of claim 1, further including
the copy device.

8. A method of controlling a creation of copies of source material, comprising:
maintaining a log of each copy of the source material, wherein the log includes an expiration time associated with at least one copy of the source material,
creating a new copy of the source material only if the log indicates that a total number of outstanding copies of the source material is below a given limit,
updating the log after the expiration time of the at least one copy has expired, so that the at least one copy is not included in the total number of outstanding copies of the source material after the expiration time of the at least one copy has expired.

9. The method of claim 8, further including
updating the log when an identified copy of the source is returned, so that the identified copy is not included in the total number of outstanding copies of the source material after the identified copy is returned.

10. The method of claim 9, further including
using a secure method of identifying the identified copy of the source.
